(19) United States
(12) Patent Application Publication
(10) Pub. No.: US 2008/0147587 A1
(43) Pub. Date: Jun. 19, 2008

(54) DECISION SUPPORT SYSTEM

(76) Inventor: Yoichi Yokoyama, Ebina (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/947,551

(22) Filed: Nov. 29, 2007

(30) Foreign Application Priority Data
Dec. 1, 2006 (JP) 2006-325134

(51) Int. Cl. G06N 5/02

(52) U.S. Cl. 706/47

(57) ABSTRACT

A system comprises a means to enter hypothetical scenario data required for decision making and data necessary for decision making scenario module, being composed of information such as an occurrence probability value and an estimated gain value, a means to enter a logical combination relation for combining the decision making scenario modules by using logical symbols or commonly used words to build a composite decision making module, a means to process, according to the logical combination relation, hypothetical scenario data corresponding to a desired composite scenario and decision making information, display the processing results in a predetermined diagram form and store them in a database, a means to search decision making scenario modules stored in the database, and a means to incorporate into a module information required for decision making and a method of processing the information.

### INCORPORATION BY REFERENCE

The present application claims priority from Japanese application JP-2006-325134 filed on Dec. 1, 2006, the content of which is hereby incorporated by reference into this application.

### BACKGROUND OF THE INVENTION

1. Field of the Invention

The present invention relates to a decision support system that supports a user in making a decision for a specific task by collecting related information, creating a scenario to handle the decision making task as a task of solving a problem of statistical decision theory and referencing and combining past scenarios to create a new scenario for decision making.

2. Description of the Related Art

As one important application of the statistical decision theory, a decision making in a corporate management is contemplated. In making a decision for a specific task, an executive officer of a corporation gathers as large a volume of information as possible and makes a decision based on scientific and objective analyses as practically as possible. In the problem of management decision making, required information is often incomplete and uncertain. Thus, a risk of making erroneous decisions cannot inherently be made totally zero.

Conventional decision making methods based on traditional statistics have employed an approach that reduces a rate of the risk of making erroneous decisions to as low a level as possible. Here, what losses a wrong decision will cause to a person who has made the decision, i.e., an economical effect of the decision, is not taken into consideration. However, if the losses the decision has incurred are slight, the decision error is not considered serious. Conversely, if a decision error incurs heavy losses even when its probability is small, the mistake is considered grave. Under these circumstances, the statistical decision theory of recent years has proposed various methods that incorporate an evaluation of economical effect of the decision into the decision theory. (Refer to prior art document 1: “Statistics of Decision Making,” by Yuzo Morita, Kodansha Gendai Shinsho, Kodansha 1971; and prior art document 2: “Introduction to Decision Making Theory; From Basics to Fuzzy Theory” by Eizo Kinoshita, Kindai-kagakusha, 1996.)

The Bayes decision theory disclosed in the prior art document 1 introduces, into a decision making frame, information on a probability distribution of various achievable states of a task for which a decision needs to be made, as prior information based on past experiences of the decision maker or his or her subjective prospects, in addition to an evaluation (expected value) of losses incurred by a decision error. That is, in creating a scenario for decision making, it is shown effective to consider past scenario data to create a new scenario.

### SUMMARY OF THE INVENTION

In making a decision based on the statistical probability described above, the following methods are considered effective for supporting a decision maker with scenario creation and thinking. A first method involves allowing the user to enter scenario information, such as a subject on which a decision should be made, an occurrence probability and an estimated gain value, in the user's own form of expression, for different scenarios with differing contents along an ordinate and an abscissa of a table form, and then causing the system itself or a predetermined program conforming to the expression form to process various kinds of scenario information. A second method similarly performs scenario diagram creation, data inputs and processing according to a step-by-step decision making tree process. A third method similarly performs scenario diagram creation, data inputs and processing by combining scenarios with a net type connection. These methods have their advantages and disadvantages and their use must be carefully determined by the user taking into consideration the scenario to be analyzed and the purpose of use. Furthermore, even if the same scenario is created for decision making, the different methods have different descriptions and expression forms, so the user needs to understand different methods and evaluate the scenario and its decision result in different manners. The user is therefore required to learn these methods.

Advantages and disadvantages of these methods are characterized as follows. The method using a table form is suited for a decision making that compares composite scenarios in which a plurality of scenario groups intersect. However, as the number of scenario groups increases to three or more or when the number of element scenarios making up the composite scenarios is large, the table becomes complex and large, rendering the creation and decision making difficult. The tree-branch type decision making tree is most widely used. However, as the number of branches increases, the understanding of the scenarios as a whole becomes difficult and particularly the relation among scenarios at terminal ends of developed branches are difficult to analyze or evaluate. The net type method is suited for creating scenarios with complex structure and for making a decision based on these scenarios. But a large volume of information concerning the scenario creation and evaluation needs to be learned.

The present invention prepares a decision making scenario module, which is a commonly or partly usable template for scenario description that allows the use of ordinary words representing logical relation, such as “and” or “or” so that the user can easily define the decision making scenarios. By applying the method and the support computer system for supporting a scenario creation and decision making by guiding according to the module structure, the user can be supported and make a decision easily based on the scenario without having to learn the individual decision making methods.

This invention provides a means to create a new decision making scenario by joining the existing decision making scenarios as element scenarios. As a result, the range of application and opportunity for using the decision making scenarios created in the past expands. The created scenarios are stored in the scenario database in the computer storage device in the form of decision making scenario module conforming to a particular format. This provides an easily guided search method. This in turn allows other scenario modules created in the past to be re-used and data of these scenario modules to be compared and analyzed, making it possible to easily perform an analysis of a decision made and an evaluation of adequacy of the result.

This invention prepares a decision making scenario module composed of a hypothesis scenario for decision making and data items required for decision making. Main data items making up the decision making scenario module (hereinafter simply referred to as a scenario module) include text data describing a scenario status, data of individual element scenario modules, such as an occurrence probability function value of the scenario of interest and/or a gain function value, and other data such as commonly used words representing logical symbols or logical relations used to combine the element scenario modules to create a composite scenario module. To display a structure of scenario modules associated with the decision making scenario module formed by module combination, information set by the user that specifies the table form, net form, tree form or predetermined item form, or a combination of these is entered and stored interactively in a guided manner.

Then, the merging of text data corresponding to the scenario modules that form the whole or a part of the desired composite state and various function values and gain values are calculated according to a logical structure between the constituent scenarios and then the decision making information for the composite scenario is displayed, printed and stored in the same form as the input form. The scenario modules created and stored are searched and displayed in a comparison table form according to a condition specified by the user or according to a data referencing condition stored in the existing scenario modules or scenario modules being created. This provides a decision support system that supports the creation of complex scenarios and the corresponding decision making.

The method for guiding the input/analysis of quantitative data and qualitative data of various scenarios without requiring the user to have any prior knowledge of the different kinds of decision making methods facilitates the decision making and evaluation and correction of the decision made. Further, after the created scenarios and the decision making information are systematically stored in the storage device of the computer, the existing scenarios and decision making information that match the user specified conditions can easily be searched and displayed in a comparison form. This makes it possible to evaluate the adequacy of the scenarios and the decision making information. At the same time, utilizing the searched scenarios and decision making information facilitates the creation of new scenarios and the corresponding decision making. As a result, the scenario-based, systematic decision making method that has conventionally been available only to a group of experts is now made available to people in general.

The above and other objects, features and advantages of the invention will become apparent from the following description of the embodiments of the invention taken in conjunction with the accompanying drawings

### BRIEF DESCRIPTION OF THE DRAWINGS

FIG. 1 shows an outline of processing executed by the decision support system of this invention.

FIG. 2A is a flow chart showing processing ranging from the guided data input/display method selection processing to the calculation result updating/storing/display processing of FIG. 1.

FIG. 2B is a flow chart ranging from the search/warning processing to the display/print processing of FIG. 1.

FIG. 3 shows a system configuration of the decision support system of this embodiment.

FIG. 4A and FIG. 4B are tables showing a data record type of the decision making scenario module which forms a scenario data template.

FIG. 5 is a configuration diagram of a scenario module database 310.

FIG. 6 is a diagram showing a combination representation method specifying a logical combination relation between a plurality of element scenarios, and a display method.

FIG. 7 shows an image of a screen of a display device 104 when a plurality of screen windows (guided scenario data input window, display method selection window and input scenario data calculation progress display window) are shown side by side.

FIG. 8 shows an example of processing executed by a text processing method and by a combination probability calculation method, both functions of a scenario combination calculation method module 303.

FIG. 9 shows an example of an evaluation reference value calculation method of the system of this invention to solve a decision making problem.

FIG. 10 shows an example of a calculation result display/storage instruction screen 404 with a column to specify data items to be stored in a scenario module database 310 and with a column to specify data items whose calculation results are to be displayed.

FIG. 11 shows an example of a search/warning condition/display/print instruction screen 405 in which to set search condition, warning condition, display instruction and print instruction for all data items of the scenario module stored.

FIG. 12 shows an example of a scenario data search result comparison display screen.

FIG. 13 shows an example of scenario text data and calculated probability values when a logical OR combination is used in combination representation method compatible scenario data calculation processing 20.

FIG. 14 shows an example of scenario text data calculation processing when a logical AND combination is used in the combination representation method compatible scenario data calculation processing 20.

FIG. 15 shows an example of probability value calculation processing when a logical AND is used in the combination representation method compatible scenario data calculation processing 20.

FIG. 16 conceptually illustrates a scenario structure in a table form when a logical OR combination is used in diagram representation method/scenario combination representation method matching processing 13.

FIG. 17 conceptually illustrates a scenario structure in a net form when a logical OR combination is used in the diagram representation method/scenario combination representation method matching processing 13.

FIG. 18 conceptually illustrates a scenario structure in a tree branch form when a logical OR combination is used in the diagram representation method/scenario combination representation method matching processing 13.

FIG. 19 conceptually illustrates a scenario structure in a table form when a logical AND combination is used in diagram representation method/scenario combination representation method matching processing 13.

FIG. 20 conceptually illustrates a scenario structure in a net form when a logical AND combination is used in the diagram representation method/scenario combination representation method matching processing 13.

FIG. 21 conceptually illustrates a scenario structure in a tree branch form when a logical AND combination is used in the diagram representation method/scenario combination representation method matching processing 13.

FIG. 22 shows an example case of creating a composite hypothesis scenario C from an element hypothesis scenario A and an element hypothesis scenario B.

FIG. 23 shows an example of a guided scenario data input screen.

FIG. 24 shows an example of a menu screen in the decision support system.

FIG. 25 shows an example of input scenario data/calculation progress display screen 403.

### DETAILED DESCRIPTION OF THE EMBODIMENTS

Now, embodiments of the present invention will be explained in detail by referring to the accompanying drawings.

### First Embodiment

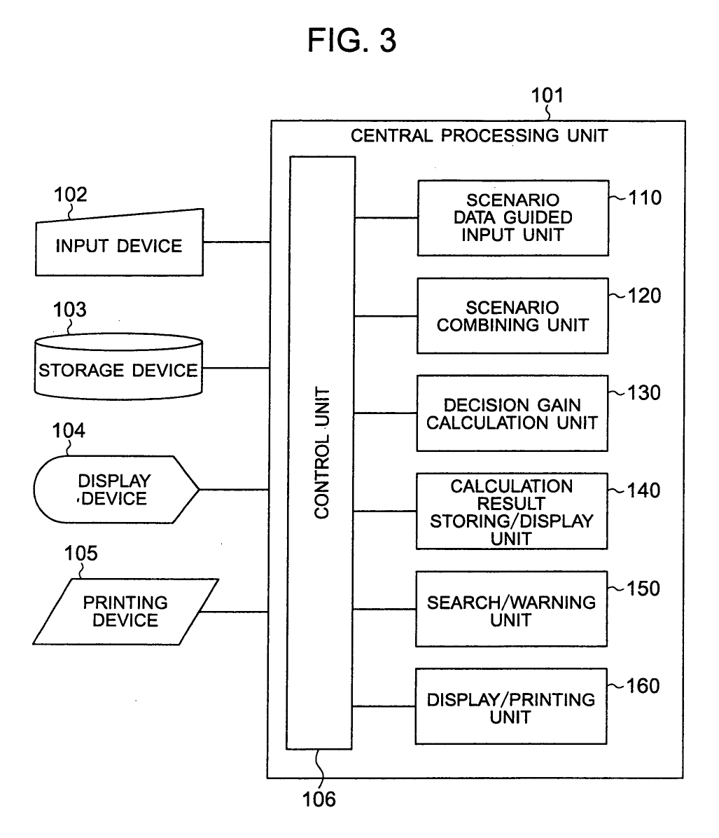

FIG. 3 shows a system configuration of a decision support system according to this embodiment. As shown in the figure, the decision support system of this embodiment comprises a central processing unit 101, an input device 102, a storage device 103, a display device 104 and a printing device 105.

The central processing unit 101 has a control unit 106, a scenario data guided input unit 110, a scenario combining unit 120, a decision gain calculation unit 130, a calculation result storing/display unit 140, a search/warning unit 150, and a display/printing unit 160.

The input device 102 accepts an input from a user by means of keyboard and mouse. In this embodiment, the user enters individual data items of a decision making scenario module according to a guide of a guided scenario data input screen on the display device 104. The user also enters a command for executing individual processing.

The storage device 103 stores individual program modules constituting the present invention and a created decision making scenario module database therein.

The display device 104 shows a decision support system menu screen, a guided scenario data input screen and various other screens on the display to support the user's input and decision making and presents a result of the decision made and an evaluation result to the user.

The printing device 105 prints out data of the created decision making scenario module, a scenario module configuration diagram, an evaluated gain value, and an evaluation result, as required.

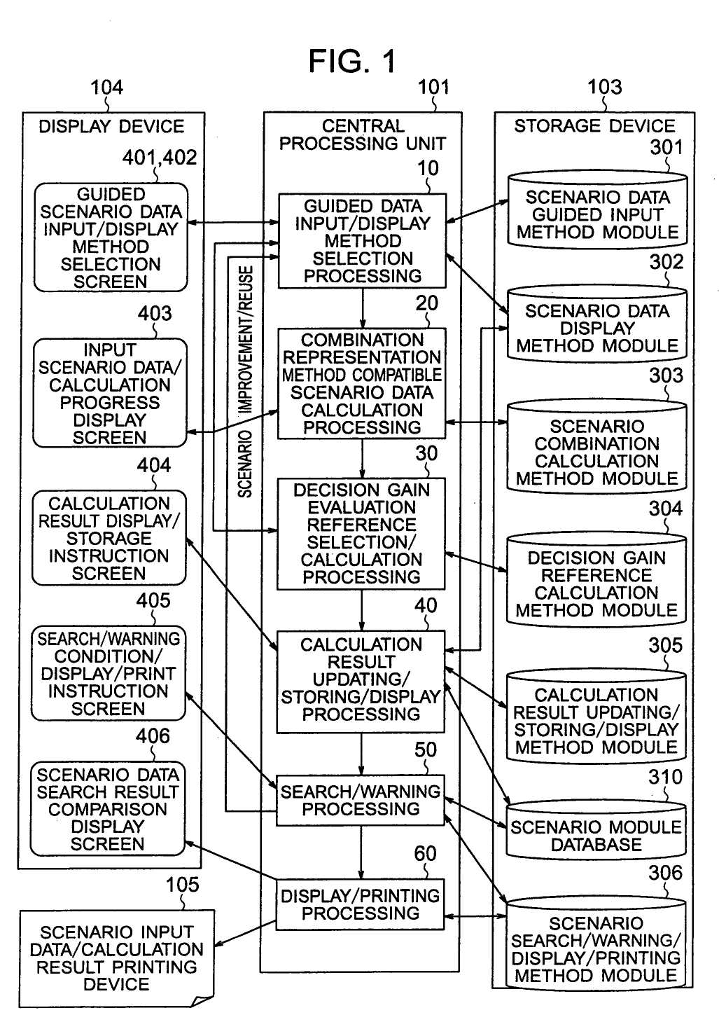

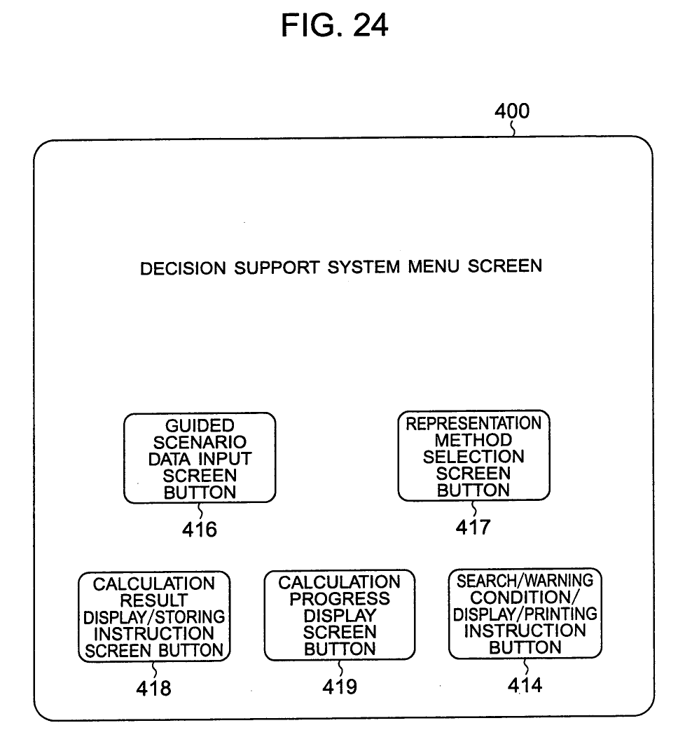

The functions realized in the central processing unit 101 of the decision support system of this invention will be explained by outlining the embodiment of this invention shown in FIG. 1. As shown in FIG. 1, when the user starts the system of the central processing unit 101, the system reads from the storage device 103 all related method program modules 301-306 en masse or any of them specified for processing and then executes them. In the central processing unit 101, the control unit 106 displays a decision support system menu screen 400 (see FIG. 24) on the display device 104 and accepts a selection by the user. According to the selection input from the user, the control unit 106 transfers execution to the scenario data guided input unit 110, the scenario combining unit 120, the decision gain calculation unit 130, the calculation result storing/display unit 140, the search/warning unit 150 or to the display/printing unit 160. In this process, a typical execution procedure, as shown in FIG. 1, has individual processing units sequentially execute the associated processing 10-60. The user, however, does not have to follow this flow chart and can have the menu screen displayed and transfer execution to any desired processing.

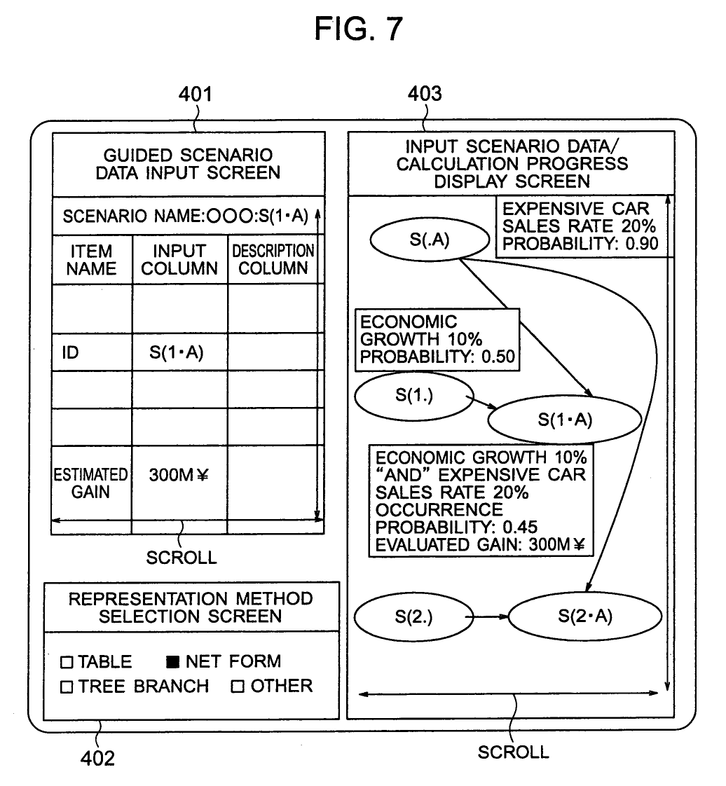

When the user clicks on a guided scenario data input screen button 416 on the menu screen 400, the system executes guided data input/display method selection processing 10 according to a scenario data guided input method module 301 and a scenario data display method module 302, thereby displaying a guided scenario data input screen 401 and a display method selection screen 402 on the display device 104 (see FIG. 7).

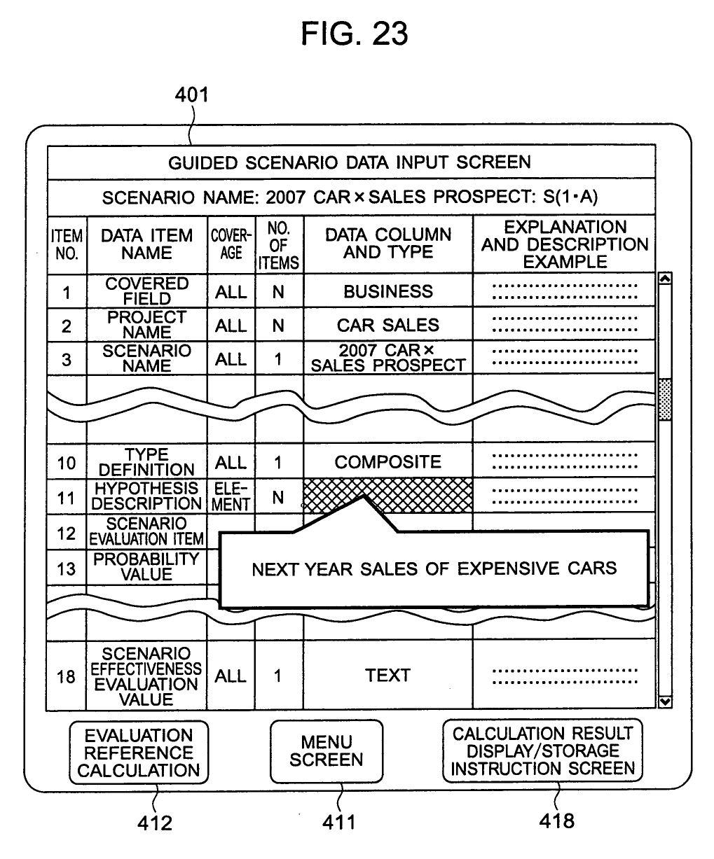

FIG. 7 shows an example in which multiple windows are displayed on the screen of the display device 104. Clicking on a desired window causes it to expand on the display screen. FIG. 23 represents an example in which the guided scenario data input screen 401 is chosen and expanded for input.

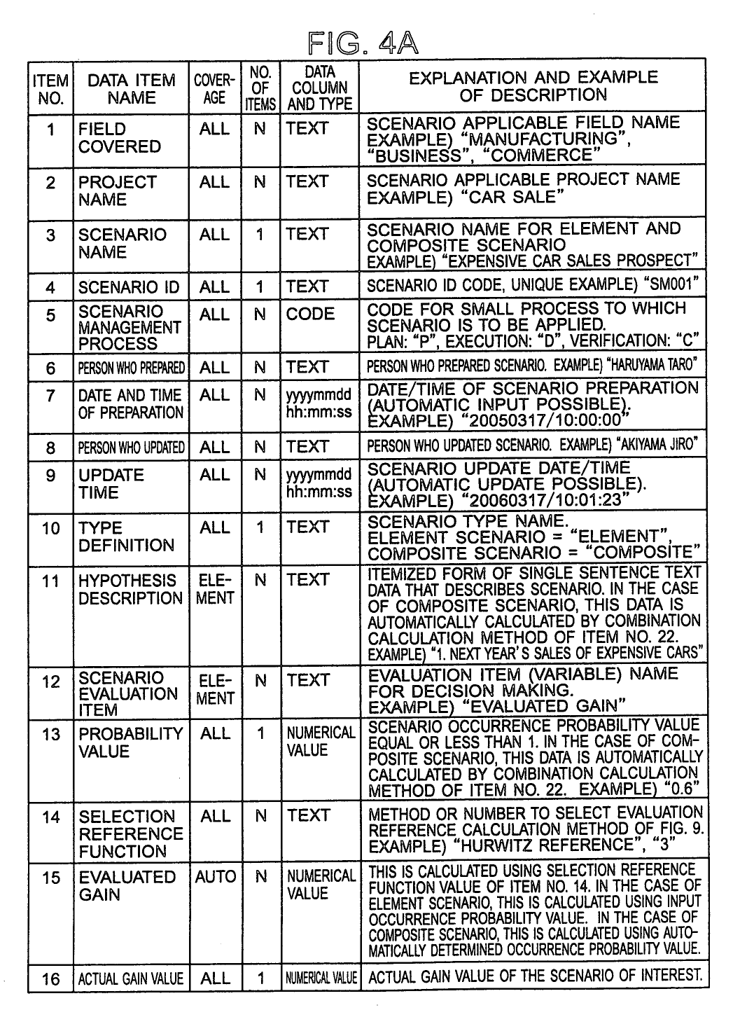

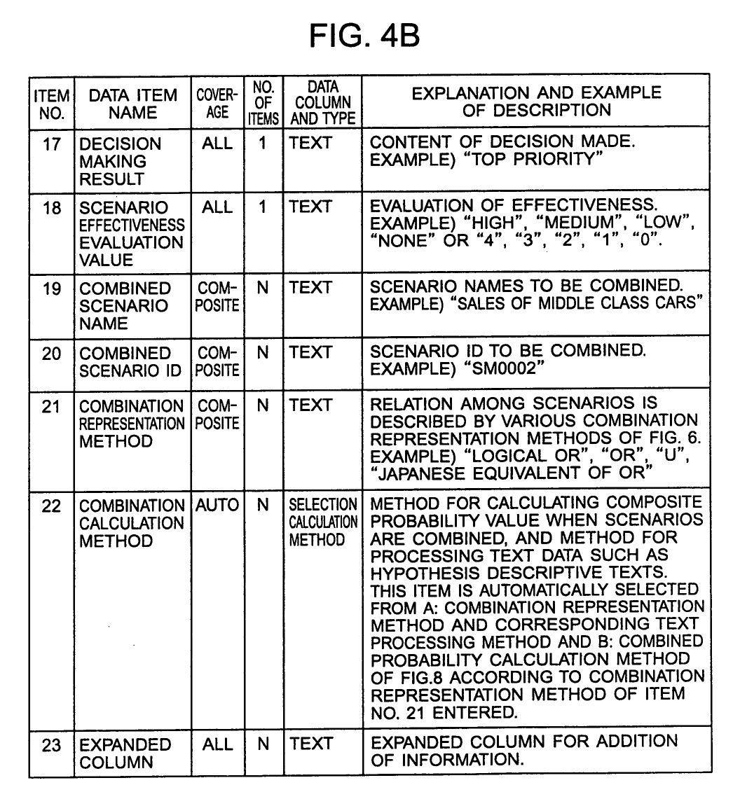

The decision support system of this invention provides a scenario data template to describe an object task on which the user is considering making a decision, a status of the task, a scenario occurrence probability value and a gain evaluation value estimated to be obtained by the decision. The scenario data template is comprised of 23 data items or a data record, as shown in a data item list of FIG. 4A and FIG. 4B. Then, the decision support system displays guide information on the display device 104 to guide the user to enter data items of the data records. The user, according to the input guide of the scenario data template, enters in a representation format of the scenario data template a scenario for making a decision on his own task.

According to the guide of the guided scenario data input screen 401, the user enters scenario module data as guided. In the display method selection screen 402 shown in FIG. 7, the user selects a scenario module data display method for the input scenario data/calculation progress display screen 403.

The scenario module data entered by the user is displayed on the input scenario data/calculation progress display screen 403 as a separate small window, according to the processing of the scenario data display method module 302, along with other combined scenario module data (see FIG. 7). In the example of the input scenario data/calculation progress display screen 403 shown in FIG. 7, a “net type” is chosen in the display method selection screen 402 and the net type model shows that a scenario module S(1.A), into which data is currently being entered, is a composite scenario module of element scenario modules S(1. ) and S(. A).

In response to the net type model display selected, the system creates from entered composite scenario module data a composite scenario module S(1.A) composed of combined element scenario modules S(1. ) and S(. A) by a scenario combination calculation method module 303 according to a logical combination representation relation described later. This involves processing various data, such as a probability value of the composite scenario module and scenario module content description text data, interactively based on input data or automatically by a combination representation method compatible scenario data calculation processing 20.

Further, according to a method of a decision gain reference calculation method module 304 that corresponds to a decision gain reference name, among many prepared beforehand by the system, which is specified by the scenario module data, the system executes a decision gain evaluation reference selection/calculation processing 30 to determine an estimated gain evaluation value when a decision is made (details will be described later). Calculation results are displayed in a small window of the input scenario data/calculation progress display screen 403, along with input results (see FIG. 7). The process of executing the calculation processing can be performed repetitively by changing the input data interactively.

Further, the input data and the calculation result obtained as a result of execution of the above processing are subjected to calculation result updating/storing/display processing 40 that is executed according to a method of a calculation result updating/storing/display method module 305 that matches the conditions specified in a calculation result display/storage instruction screen 404. Then, updated scenario data is automatically created one after another according to the specified updating of scenario data and is displayed on the input scenario data/calculation progress display screen 403 for user confirmation. At the same time, by storing the updated scenario data in a decision making scenario module database 310, the scenario calculation result representing the updated data can be stored.

The scenario data stored in the decision making scenario module database 310 is subjected to search/warning processing 50 and display/printing processing 60 that are executed according to a method of a scenario search/warning/display/printing method module 306 that matches the scenario search conditions and the warning/display/printing conditions specified in a scenario search condition input display/printing method specification screen 405. The results of these processing are displayed by the specified comparison display method and printed by the scenario input data/calculation result printing device 105. Of the above constitutional elements, main constitutional elements are explained in detail as follows.

FIG. 4A and FIG. 4B show a data structure of the decision making scenario module data according to this invention. One data record of the decision making scenario module data in this invention is composed of 23 data items numbered 1 to 23 as shown in an item number column. Each data item, as indicated in a data item name column, is given a name for its identity. Each data item has guide information defined in columns “coverage”, “number of items”, “data column and type” and “explanation and example of description” which provides guidance when data is entered into the data column. The guide information in these columns is registered with the scenario data guided input method module 301 as the decision making scenario module data definition information in a table format as shown in FIG. 4A and FIG. 4B. The table format definition information can easily be accessed for reading and writing by other table format calculation programs and optimization programs. Data items can be added to the table format definition information, as required.

In the decision making scenario module data shown in FIG. 4A and FIG. 4B, data items with their coverage column written with “all” are those data items that need to be entered into element and composite types of scenario modules, those with “element” are data items that should be input to only the element scenario modules, and those with “composite” are data items that should be entered into only composite scenario modules. Data items with “auto” are those that are automatically calculated and entered, but their calculation results can be edited as required.

The number of items in the decision making scenario module data definition information signifies the number of repetitions of each data item. “1” indicates that data for the associated data item can be written (or entered) into the data column once, and “N” indicates that data for the associated data item can be written (or entered) into the data column two or more times, up to 255 times, thus providing guidance when the user enters data.

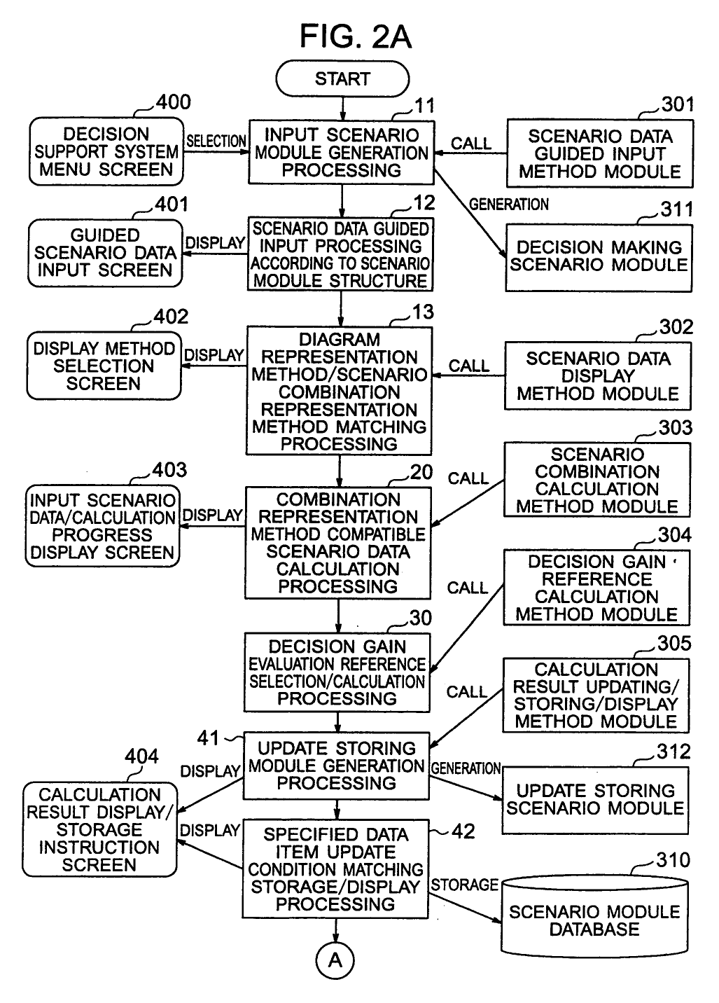

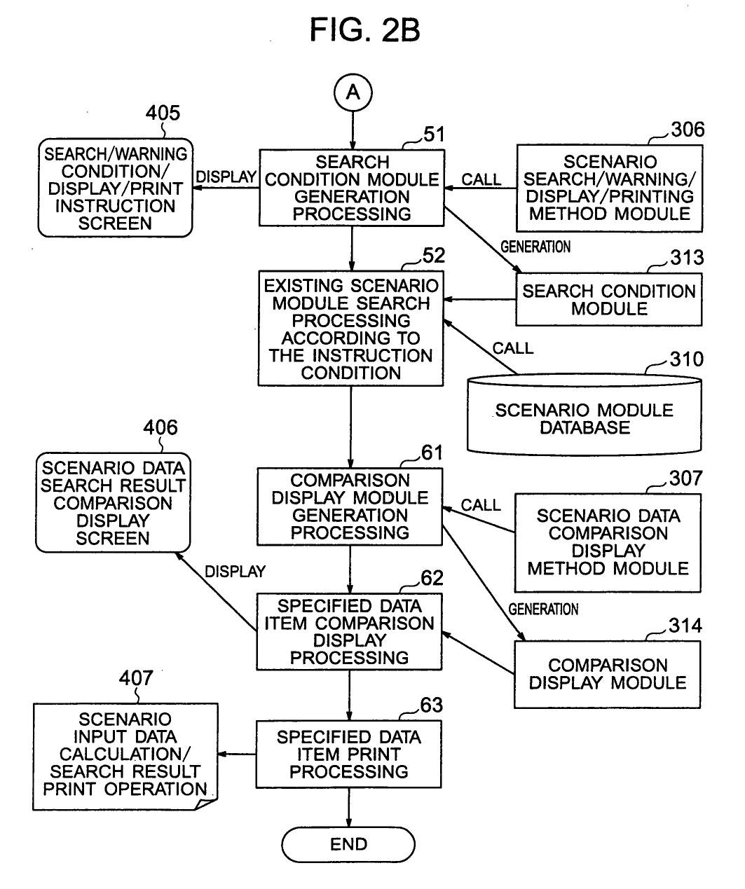

Next, the processing shown in the system outline of FIG. 1, from the guided data input/display method selection processing 10 to the calculation result updating/storing/display processing 40, will be explained based on the decision making scenario module data definition information, according to the process flow of FIG. 2A and FIG. 2B.

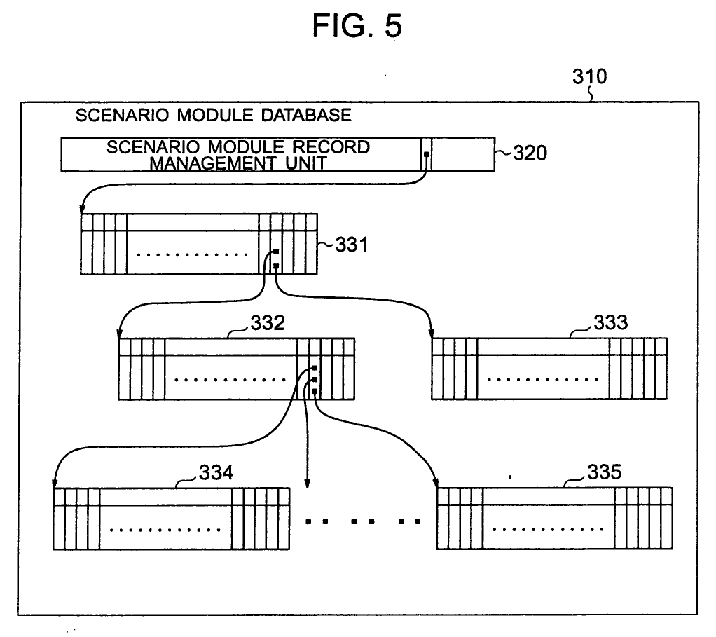

First, the guided data input/display method selection processing 10 of FIG. 1 will be explained by referring to FIG. 2A and FIG. 2B. When the user starts this system, the system displays the decision support system menu screen 400 (see FIG. 24) and waits for the user to make a selection, as described above. The user's clicking on the guided scenario data input screen button 416 causes the system to execute input scenario module generation processing 11 to call into the system the scenario data guided input method module 301 that defines the data items making up the scenario module. Then, to hold succeeding inputs and scenario data generated by calculations, the scenario data guided input method module 301 creates a decision making scenario module 311 having a new data record number (corresponding to the scenario ID of FIG. 4A). This decision making scenario module 311 is hereinafter simply described to be a scenario module. The decision making scenario module 311 secures a new data record area in the decision making scenario module database 310 in the form of a table that, for each data item defined in FIG. 4A and FIG. 4B, consists of a data column and a number of items column indicating the number of data items to be registered in the data column (see FIG. 5).

Next, scenario data guided input processing 12 causes the guided scenario data input screen 401 to display a guide for scenario data input. As shown in an example screen of FIG. 23, for each data item of the decision making scenario module data defined in FIG. 4A and FIG. 4B, definition information, description and description example are displayed as guide information to guide the user as he enters data into the data column while indicating that the data column of interest is waiting for an input. The user defines the decision making scenario module 311 basically by entering data beginning with the data item of item number 1. The order of input may not necessarily be the order of item number, and the user may change the order of input by specifying data items in a desired input order.

As shown in the example of FIG. 23, data for each data item is entered into the associated data column either directly or by clicking on the data column to expand the input window and writing into the input window. The user looks at the explanation and the example of description displayed on the screen as he enters data. The entered data is displayed in the data column.

For data items with “1” defined in the number of items column, the input process is completed by one data input. For data items with “N”, data input is performed a plurality of times in principle. That is, after the user finishes one data input, the system displays a message asking if there is another data input. If the user has the next data input, he or she repeats the data input. When there is no more data input for that data item, the user returns a message saying that the data input is complete. The system now finishes the data input for that data item and proceeds to data input processing for the next data item.

The entered data is automatically checked according to the data type, coverage and the number of items defined for each data item. If there is any input error, an error message is displayed as required.

The guided scenario data input screen of FIG. 23 shows data currently being entered into the data column of item number 11 of data item “hypothetical description”. Data has already been entered into the data items of item number 1 to item number 10, with input data shown in the data column. The input screen also shows that data has yet to be entered into the data column for item number 18 “scenario effectiveness evaluation”, with “text”, which represents a type of data to be entered, shown in the data column according to the definition information.

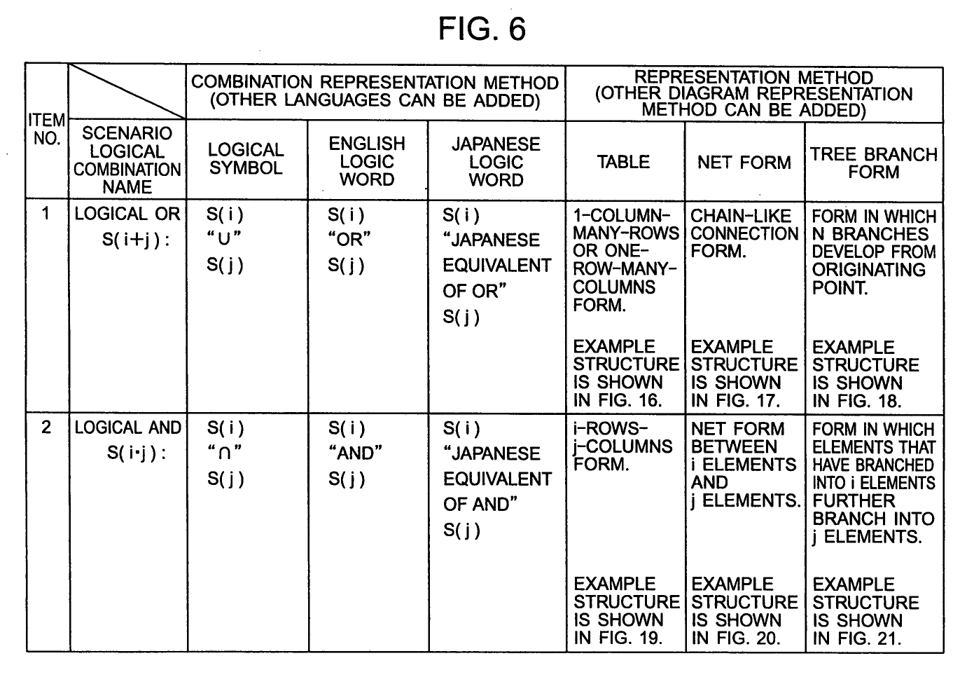

Of the data items of the decision making scenario module data definition information shown in FIG. 4A and FIG. 4B, item number 10 “definition of type” has its data entered as follows. When the scenario module is made up of one hypothesis, an “element” scenario is entered. When the scenario module is made up of a plurality of hypotheses, a “composite” scenario is entered. According to the scenario type, the following input guide and various calculation operations are performed. As exemplified in FIG. 4B, item number 19 “combined scenario name”, item number 20 “combined scenario ID” and item number 21 “combination representation method” are consolidated in the input guide in the case of the “composite” scenario. In entering data for the item number 19 “combined scenario name”, the user enters a plurality of scenario names of element scenarios to be combined. In the case of item number 20 “combined scenario ID”, the user simply enters a plurality of scenario IDs of the element scenarios to be combined. In the data input for item number 21 “combination representation method”, the user enters a relation among a plurality of element scenarios to be combined which have been entered for item number 19 or 20, by specifying one of combination representation methods shown in FIG. 6.

Further, when the user clicks on a representation method selection screen button 417 on the decision support system menu screen 400 (see FIG. 24), the system executes diagram representation method/scenario combination representation method matching processing 13 of FIG. 2A. The system reads the scenario data display method module 302 and displays the display method selection screen 402, prompting the user to make a selection. The display method selection screen 402 allows the user to choose a display method, such as a table form, a net form or a branched tree form, in presenting to the user the data of the scenario module, such as the subsequent input data and calculation progress data, and a logical consolidation structure among scenario modules.

When the user specifies a display method on the display method selection screen 402, the system interactively displays on the input scenario data/calculation progress display screen 403 (see FIG. 7) the scenario configuration and scenario module data currently being processed by the input/calculation processing according to the purpose and the specified representation method.

In creating a composite scenario module by combining the registered element scenario modules on the guided scenario data input screen 401, the user of the system of this invention enters a scenario logical combination method in the data column of item number 21 “combination representation method” of FIG. 4B. As an example of scenario logical combination method of this invention, FIG. 6 shows an example of combination representation method and display method for a “logical OR” and a “logical AND”. S(i) and S(j) in the figure represent decision making scenario modules (hereinafter described as scenarios) for i and j. In FIG. 6, S(i+j) represents a composite scenario created by the logical OR of scenarios S(i) and S(j). S(i·j) represents a composite scenario created by the logical AND of scenarios S(i) and S(j).

By handling the existing composite scenario modules as element scenario modules, composite scenario modules involving both logical OR and logical AND can be dealt with. For example, S(S(1+A)·S(B)) is permissible. In FIG. 6, an ordinate “scenario logical combination name” and an abscissa “combination representation method” can be expanded up to 100 rows and 100 columns, as required.

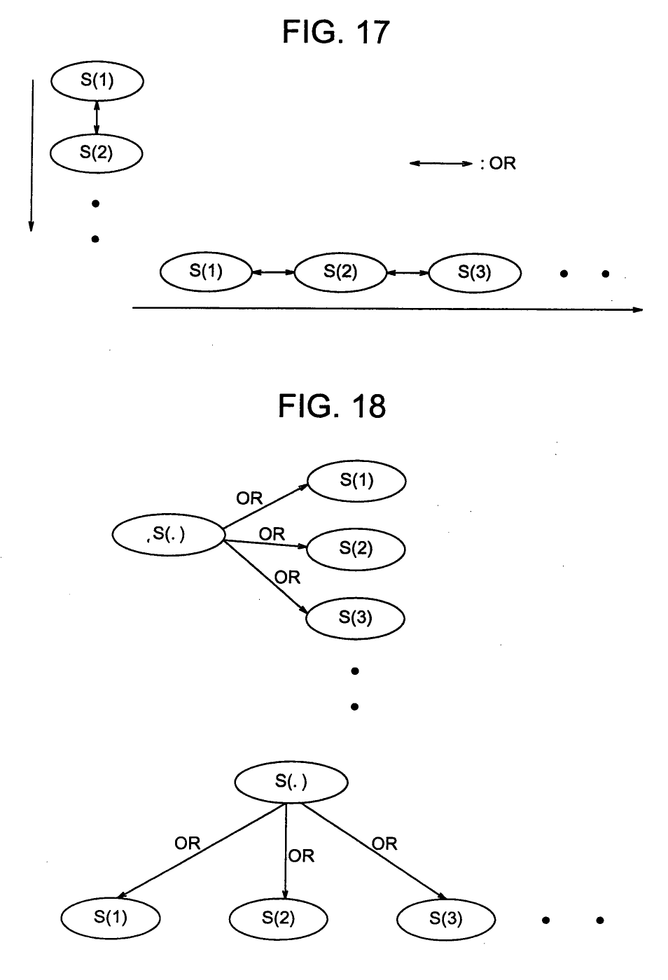

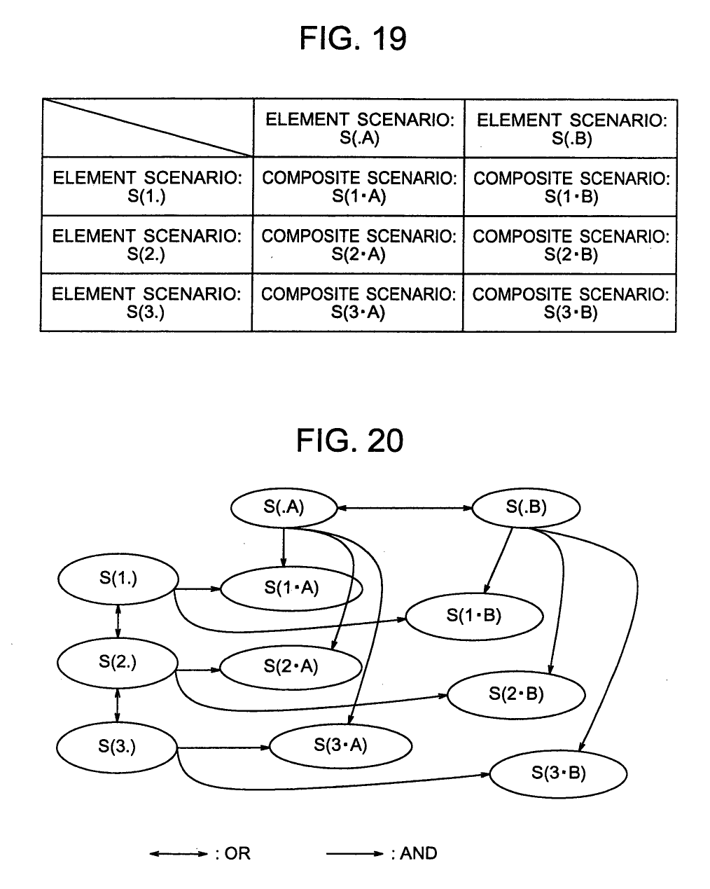

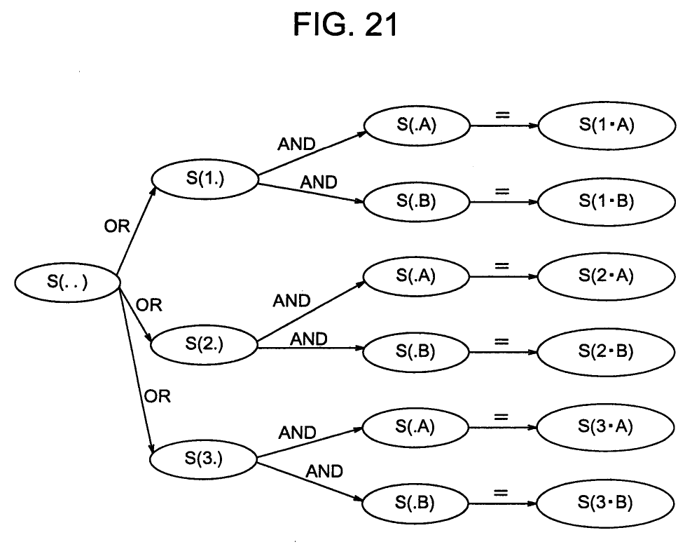

Example representation methods for logical OR—table, net and branched tree forms—are shown in FIG. 16, FIG. 17 and FIG. 18. Example representation methods for logical AND—table, net and branched tree forms—are shown in FIG. 19, FIG. 20 and FIG. 21.

FIG. 7 shows, side by side, the windows for the guided scenario data input screen 401, the display method selection screen 402 and the input scenario data/calculation progress display screen 403. The diagrams and tables shown in the screen 403 are editable interactively and the result is automatically reflected in the associated scenario module.

Next, the data calculation processing for a composite scenario module performed according to the input data will be explained as follows.

First, the calculation processing, such as text data processing method and probability value calculation method, as performed by the combination representation method compatible scenario data calculation processing 20 in FIG. 1 and FIG. 2 will be explained. If there are already a plurality of input scenario modules, the processing 20 enables a composite scenario module to be created by combining these element scenario modules through a logical relation, such as logical OR or logical AND. As described above, if a composite scenario is defined in the item number 10 “type definition” of FIG. 4A, the data input in the decision making scenario module data definition of FIG. 4B is guided for (1) item number 19 “combined scenario name”, (2) item number 20 “combined scenario ID” and (3) item number 21 “combination representation method”.

When, of these data items of the composite scenario module, (3) the item number 21 “combination representation method” is entered, the text data calculation processing method for the item number 11 “hypothesis description” and item number 12 “scenario evaluation item” that are already entered in FIG. 4A and the calculation method for the item number 13 “probability value” are selected and executed by the associated calculation operation program from the scenario combination calculation method module 303.

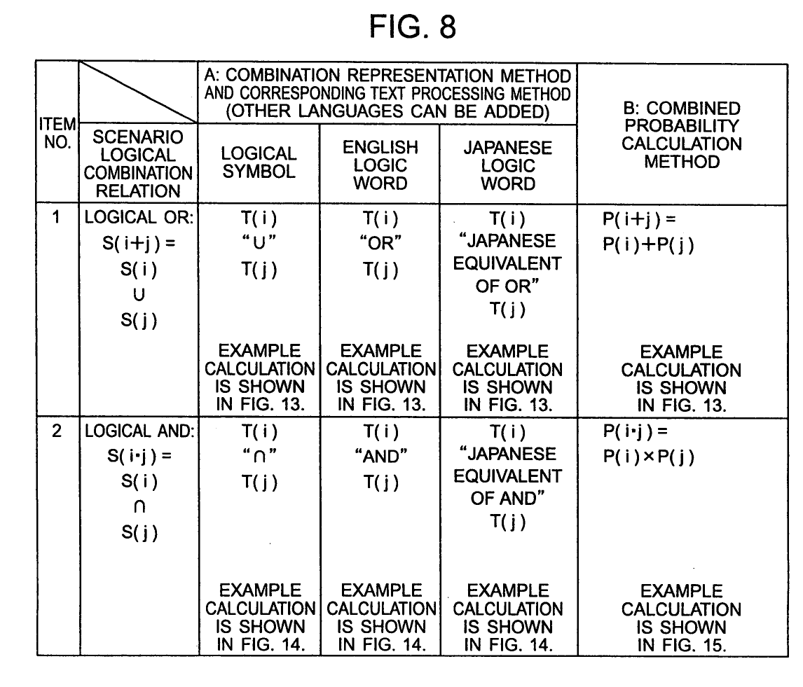

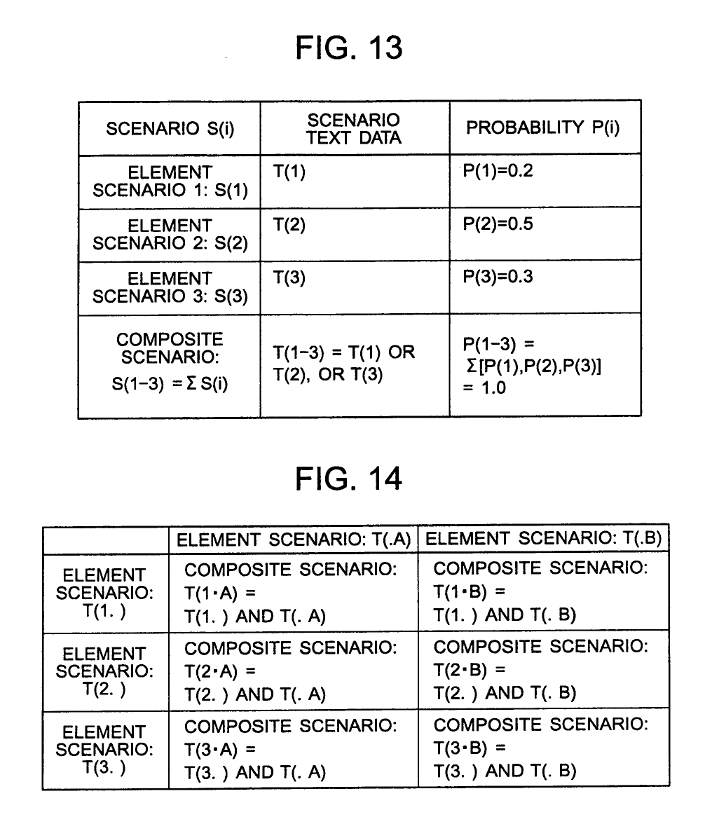

FIG. 8 shows a table explaining the functions of the scenario combination calculation method module 303. In FIG. 8, “A: combination representation method and compatible text processing method” corresponds to (3) item number 21 “combination representation method” and various text data processing methods. T(i) and T(j) represent text data for scenario i and j. If, for example, a “logical OR” is entered into the item number 21 “combination representation method”, the text data of item number 11 “hypothesis description” in the composite scenario, i.e., the text data in the item number 11 “hypothesis description” of the element scenarios to be calculated, are connected together by “or”, as shown in the table of FIG. 13, to create new text data. And if, for example, a “logical AND” is entered in the item number 21 “combination representation method”, the text data in the composite scenario's item number 11 “hypothesis description”, i.e., the text data in the item number 11 “hypothesis description” of the element scenarios to be calculated, are connected together by “and”, as shown in the table of FIG. 14, to create new text data. The calculated result is stored as text data of item number 11 “hypothesis description” in a composite scenario module data record.

In FIG. 8, calculation equations shown in a “B: combination probability calculation method” column are automatically selected according to the input data of item number 21 “combination representation method” and then stored in the data column for item number 22 of data item “combination calculation method”. P(i) and P(j) represent occurrence probability values of scenario i and j, respectively. P(i·j) represents an occurrence probability value of a composite scenario, i.e., a probability of the scenario i and scenario j occurring at the same time.

Similarly, scenarios can be expanded from two or three—i, j and k—to a large number. The system can also deal with composite scenario modules containing both logical OR and logical AND by handling the existing composite scenario modules as element scenario modules.

This can also be applied to groups of scenario modules. In FIG. 8, the number of items in the ordinate can be expanded to 255 rows and the abscissa column “A: combination representation method and compatible text processing method” can be expanded to 255 columns. The number of calculation processing methods in the abscissa can be expanded to 255 methods in addition to A and B. The method of expansion includes existing optimization methods. In combination with these methods, calculation results and input value data can be made optimal.

The representation type entered in the item number 21 “combination representation method” in FIG. 4B allows logical relations connecting element scenarios, such as logical OR or logical AND, to be represented by logical symbols, such as “◯” and “◯”, by ordinary English logical relational words, such as “AND” and “OR”, or by equivalent ordinary Japanese words, as shown in the column “A: combination representation method and compatible text processing method” of FIG. 8. These representation methods can also be expanded to 255 methods.

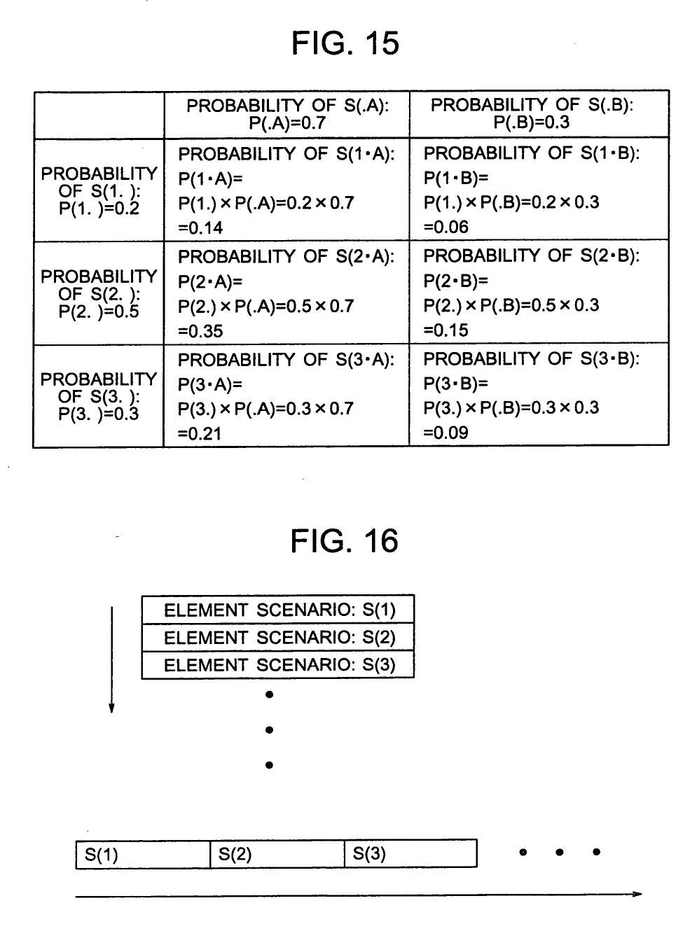

The system, according to the combination representation method and the calculation operation method described above, automatically calculates the item number 11 “hypothesis description” of a composite scenario module composed of a plurality of element scenario modules and the item number 13 “probability value”. Examples of these processing are shown in FIG. 13, FIG. 14 and FIG. 15. FIG. 13 shows an example of text data processing and an example of probability value calculation in the logical OR combination. FIG. 14 shows an example of text data processing in the logical AND combination. FIG. 15 shows an example of probability value calculation in the logical AND combination.

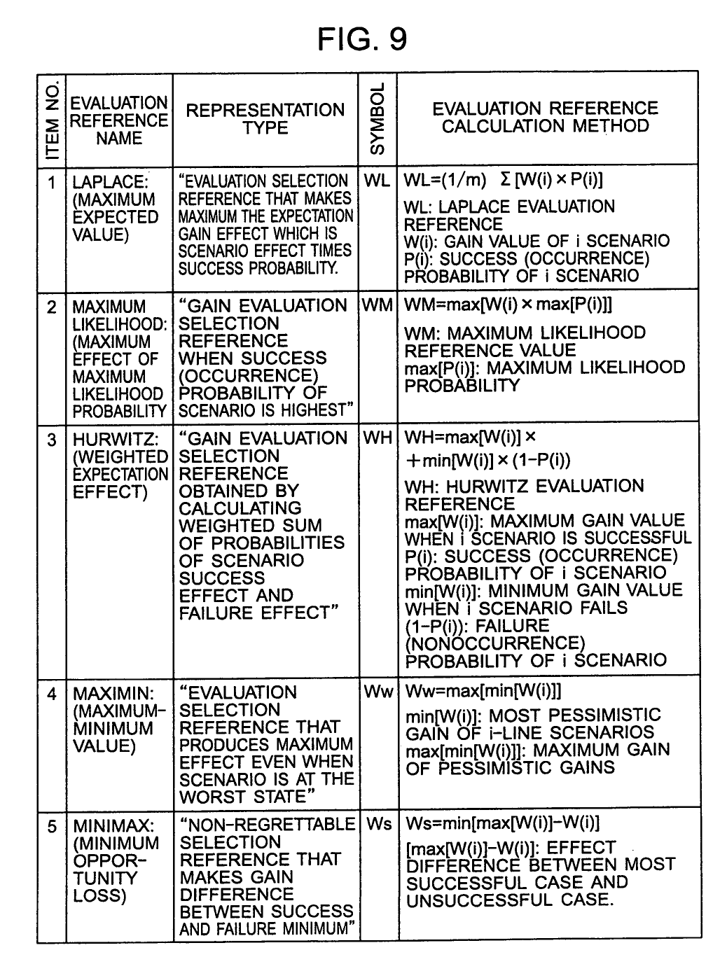

Next, the decision gain evaluation reference selection/calculation processing 30 in FIG. 1 and FIG. 2A will be explained. The item number 15 in FIG. 4A “evaluated gain”, which serves as a quantitative evaluation reference for decision making, is calculated by a calculation program of the decision gain reference calculation method module 304 corresponding to the item number 13 “probability value” obtained from the combination representation method compatible scenario data calculation processing 20, the item number 16 “actual gain value” entered by the user and the item number 14 “selection reference function” specified by the user. FIG. 9 shows an example of evaluation reference value calculation method to solve a decision making problem. Five evaluation reference value calculation methods shown in FIG. 9 can be said to be rules for making a decision based on a predetermined theory. These evaluation reference value calculation methods can be expanded up to 255 methods, as required. At the same time, two or more methods can be selected. The program for the evaluation reference value calculation method is incorporated in the decision gain reference calculation method module and registered with the storage device 103.

The scenario module data, described above, is entered into individual data columns on the guided scenario data input screen 401 on the display device 104. Alternatively, the data input can be achieved by entering a combination scenario specification in item number 19 or 20 in FIG. 4B to specify the existing scenario modules as element scenario modules to be combined.

Then, when a method name or number to select the evaluation reference value calculation method of FIG. 9 is entered in the data column of item number 14 “selection reference function” of FIG. 4A and the evaluation reference value calculation button 412 on the guided scenario data input screen 401 is clicked, the evaluation reference value calculation processing executes the associated evaluation reference value calculation method program to determine the item number 15 “evaluated gain” value. The calculated “evaluated gain” value is recorded as a value of the data item “evaluated gain” of the decision making scenario module 311. At the same time, the value of calculated result is displayed in the data column of item number 15 “evaluated gain” data item on the guided scenario data input screen.

The data input and the evaluation reference value calculation processing described above can be repetitively performed interactively on the guided scenario data input screen by the user changing the input data conditions.

The user or decision maker, after checking the result of the evaluated gain thus calculated and making a decision, enters the content of the decision made into the scenario module's item number 17 of data item “result of decision made” in the text form. If the result of the evaluated gain has been checked but a decision has yet to be made, a record that evaluates an effectiveness of the scenario under consideration is entered into the scenario module's item number 18 of data item “scenario effectiveness evaluation value” in the text form. After this scenario module is registered, it can be referenced afterwards for evaluation of scenario module and for decision making.

Next, following the calculation processing, a process of displaying the scenario module data and storing it in a database will be described.

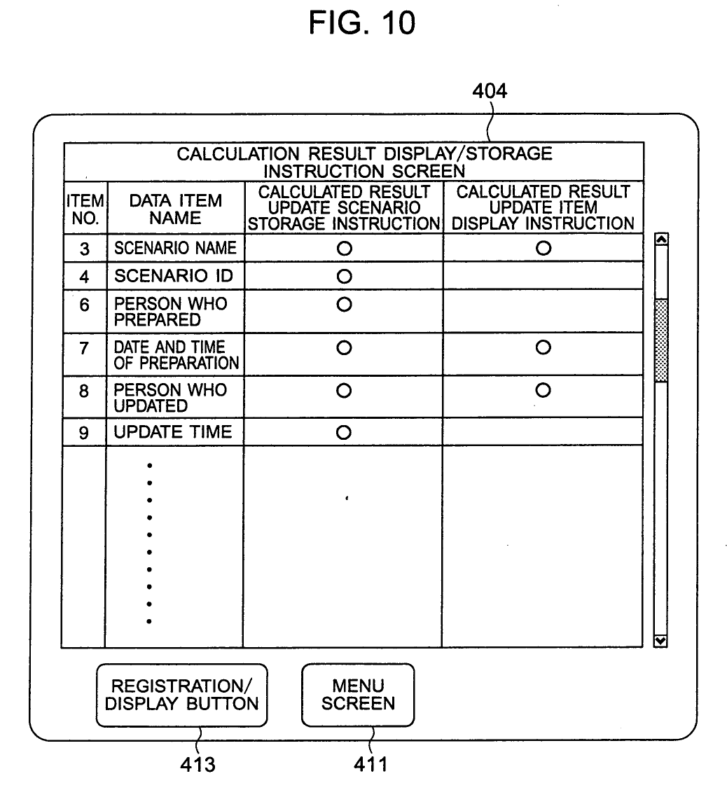

The calculation result updating/storing/display processing 40 in FIG. 1 will be explained according to a detailed process flow of FIG. 2A. First, the system calls the calculation result updating/storing/display method module 305 and, according to the processing of the module, displays the calculation result display/storage instruction screen 404. This calculation result updating/storing/display method module 305 is started by clicking on the calculation result display/storage instruction screen button 418 on the guided scenario data input screen 401. The module 305 is also started by clicking on the calculation result display/storage instruction screen button 418 on the decision support system menu screen 400. The processing accepts a user instruction input in the calculation result updated scenario storage instruction column and the calculation result updated item display instruction column on the calculation result display/storage instruction screen 404 of FIG. 10, with data items of scenario module, whose record types are shown in FIGS. 4A and 4B, arranged in the ordinate. The user enters his or her instruction by clicking on the inside of a lattice in each column for individual data items to specify a circle symbol. Clicking again eliminates the instruction. Only those data items marked with ◯ in the calculation result updated scenario storage instruction column are registered with the decision making scenario module database 310 as data for a new scenario module. If the scenario module specified by the scenario ID is already registered with the decision making scenario module database 310, only the data items of the already registered scenario module that correspond to the data items marked with ◯ in the calculation result updated scenario storage instruction column have their data updated.

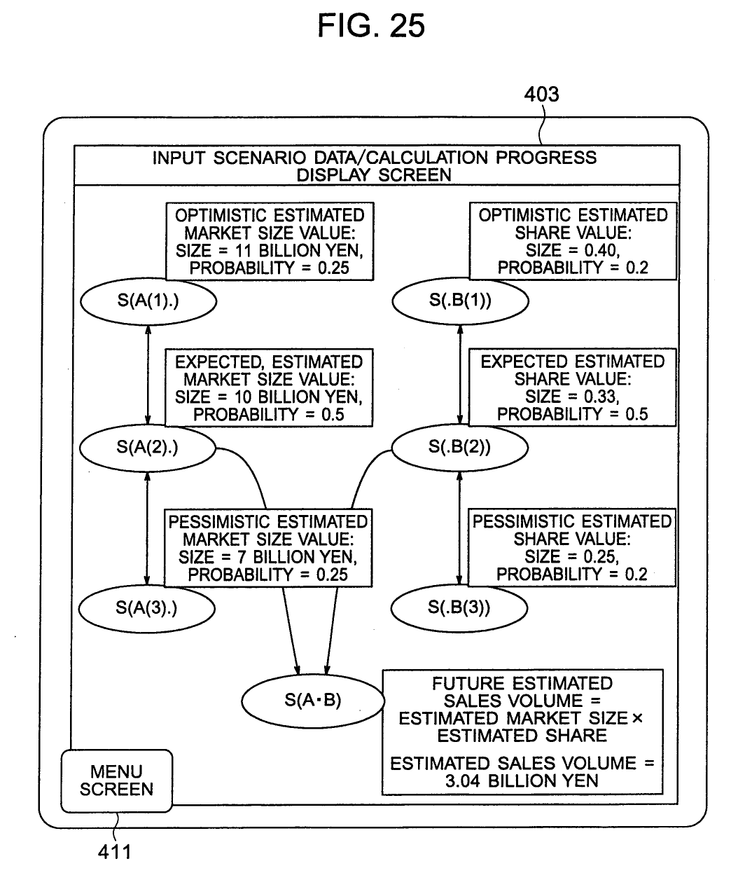

The user also attaches ◯ to only desired data items in the calculation result updated item display instruction column to make an instruction to match the selected data item names with data values before displaying them. This display can be returned to, for example, to the menu screen 400 and the user may click on the calculation progress display screen button 419 to call up the input scenario data/calculation progress display screen 403 of FIG. 25 and may display on the screen 403 a model configuration of a composite scenario, including the scenario currently being entered and other scenarios used to create the composite scenario, in the net form specified on the display method selection screen 402, thus supporting the user in understanding the scenario module. Which of the data items of each scenario in the displayed model is to be displayed is chosen by the symbol ◯ marked in the calculation result updated item display instruction column. FIG. 25 shows an example display when the data items of scenario name, scenario evaluation item, probability value and actual gain value are marked with ◯ (this display differs from the display example of FIG. 10 with ◯ marked in the calculation result updated item display instruction column on the calculation result display/storage instruction screen 404). Only the selected data is displayed near the symbol of each scenario.

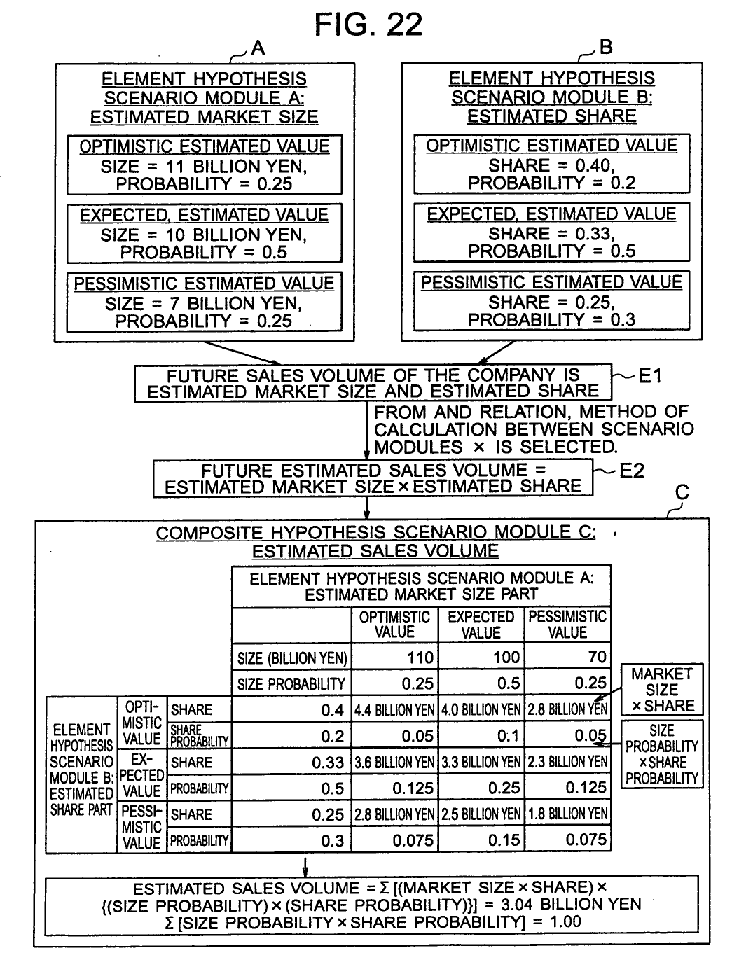

As another method of display, various diagram/table display programs may be used to display the calculation results for the data items selected by ◯ marked in the calculation result updated item display instruction column, as with a composite hypothesis scenario module C in FIG. 22. These instruction inputs, once entered, become a default for subsequent data input operations.

In the update storing module generation processing 41 of FIG. 2A, the “decision making scenario module” 311 created by the operation of the scenario data guided input method module 301 is newly re-created as an “update storing scenario module” 312. When the user clicks on the “registration/display” button 413 on the calculation result display/storage instruction screen 404, the processing 41 stores the “update storing scenario module” 312 in the decision making scenario module database 310. In this storage process, the specified data item update condition matching storage/display processing 42 automatically stores in the decision making scenario module database 310 a new scenario module incorporating updates of the data items specified in the calculation result updated scenario storage instruction column and the calculation result updated item display instruction column on the calculation result display/storage instruction screen 404 of FIG. 10. At the same time, the processing 42 also displays the new scenario module.

FIG. 5 schematically shows a structure of the decision making scenario module database 310. A scenario module record management unit 320 manages a physical address pointer to each registered scenario module record. Each scenario module is stored as a data record in a table form that comprises 23 data items and a data column as shown in FIGS. 4A and 4B. In FIG. 5, the scenario module record denoted 331 represents a highest level composite scenario module. The composite scenario module 331 is comprised of two intermediate element scenario modules 332, 333 combined. Further, the intermediate element scenario module 332 is shown to be a composite scenario module constructed of element scenario modules 334, 335, . . . combined. From each composite scenario module a logical pointer is formed that points to each of the element scenario modules to be combined. The logical pointers are stored in the data column of item number 20 “combined scenario ID”.

If a new composite scenario module having the scenario module 331 as an element scenario module is registered, a logical pointer is formed that originates from the composite scenario module record and points at the composite scenario module record 331. In this way a composite scenario module is formed by combining individual scenario module records by logical pointers.

When new scenario module data is registered with the scenario module database 310, a table-structured record area is secured for the storage of data of each data item. At the same time, the physical pointer and the logical pointer are set. When the scenario module data is updated, data of the associated data item is updated.

Next, processing of search and display of scenario modules stored in the scenario module database 310 will be explained.

The search/warning processing 50 of FIG. 1 will be explained by following a detailed flow of processing executed by the associated processing units 51-52 of FIG. 2B. When the user clicks on a search/warning condition/display/printing instruction button 414 on the decision support system menu screen 400, the system calls in the scenario search/warning/display/printing instruction module 306 and starts it to display the search/warning condition/display/print instruction screen 405.

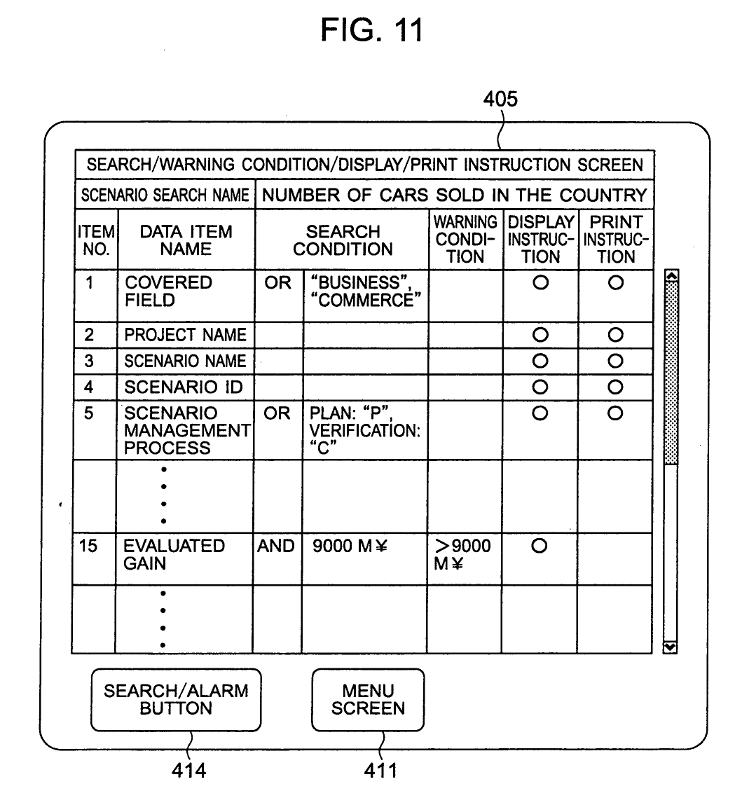

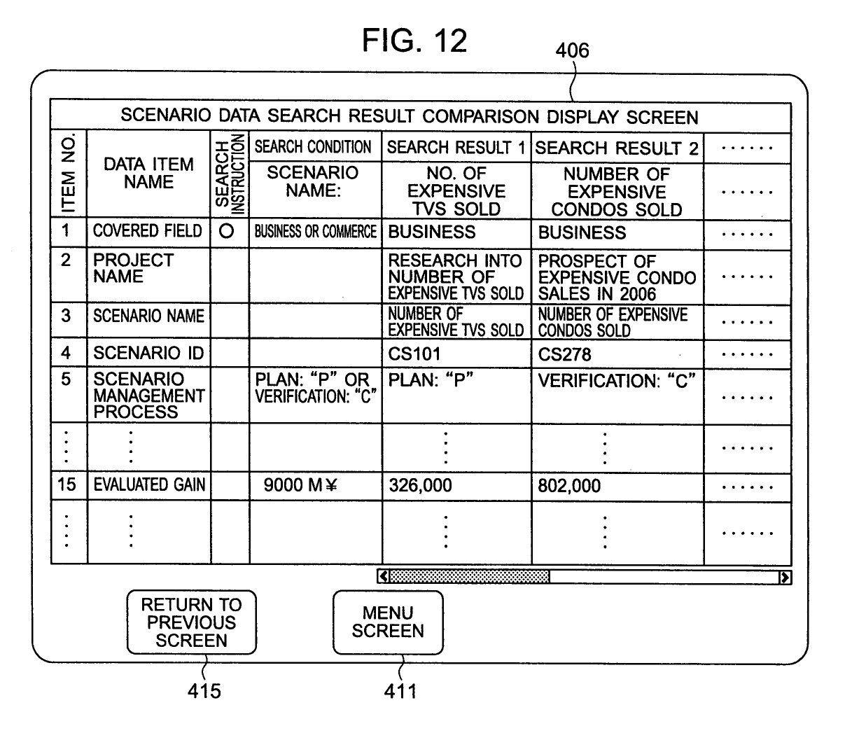

On the search/warning condition/display/print instruction screen 405 shown in FIG. 11, the user sets and enters the search condition, warning condition, display instruction and print instruction for all data items of the stored scenario module. For example, in setting and entering the search condition, the user selects a desired data item from among the data items of FIGS. 4A and 4B arranged along the ordinate and enters in the associated columns the text to be searched or numerical value and a logical symbol for combination. With the search condition set and entered, the user clicks on the search/warning button on the screen to initiate a search through only those of the scenario modules registered with the scenario module database 310 which conform to the search condition (step 52). In all of the searched scenario modules, only the data items for which the display instruction was made on the search/warning condition/display/print instruction screen 405 are displayed on a scenario data search result comparison display screen 406 (step 62) shown in FIG. 12. FIG. 12 shows an example in which another search is made through all the scenario modules that have matched the first search condition to find, select and display only those scenario modules which satisfy an additional search condition that the data item name “field covered” is “business” or “commerce”. All the search results are displayed on the screen by scrolling.

In the search/warning condition/display/print instruction screen 405 of FIG. 11, the warning condition is shown to include, for example, “>9000MY=” set in the data item “actual gain value”. After this condition setting is made, the user clicks on the search/warning button 414 to register the warning condition with the storage device 103. Then, the processing to calculate the evaluated gain value of the scenario modules is executed so that when the item number 15 “evaluated gain” of any scenario module reaches a state satisfying the condition “>9000MY=”, a warming message and the scenario module in question are displayed. For example, data of the scenario module in question is displayed in the data column on the guided scenario data input screen of FIG. 23.

The result of setting by the user of the search condition, warning condition, display instruction and print instruction in the search/warning condition/display/print instruction screen 405 is used by search condition module generation processing 51 of FIG. 2B to create, for each condition input, a search condition module 313 holding the associated condition and store the newly created module in the storage device 103.

According to the search condition and the warning condition set by the user, data items specified by these conditions are connected by logical “OR” and logical “AND”. The conditions, such as display instruction and print instruction, are selected from all data items. According to these conditions, existing scenario module search processing 52 is executed.

As for the result of search and warning processing, a scenario data comparison display method module 307 of FIG. 2B is started to execute comparison display module generation processing 61 to generate a comparison display module 314 which stores the result of search and warning processing in the storage device 103.

The data in the comparison display module 314 is displayed, through specified data item comparison display processing 62, on the scenario data search result comparison display screen 406 (FIG. 12). Further, the results of data items for which the print instruction was made are printed by a scenario input data calculation/search result print operation 407 through specified data item print processing 63.

The decision making scenario module has a table structure that allows easy data exchange with or easy module export/import to and from general table calculation programs, making it possible to cooperate with various table calculation programs and optimization programs and even diagram display programs to generate a variety of kinds of reference materials and optimize them for display in a desired form.

### Second Embodiment

As one example, a decision making process to estimate a future sales volume of a company's product is shown in FIG. 22.

The user recognizes that the sales volume is obtained by multiplying a market size and an estimated share, and executes the following scenario module generation processing and calculation processing.

The process the user executes by the decision support system of this invention to calculate an estimated sales volume involves selecting a calculation type X of the equation E2 from the element hypothesis scenario module A: “estimated market size” and element hypothesis scenario module B: “estimated share” and from the AND relation of relation description E1 about hypotheses A and B and generating a composite hypothesis scenario module C: “estimated sales volume” from the element scenario modules A and B.

In the scenario module input processing described below, some data inputs of basic data items of scenario module, such as “field covered”, “scenario name”, “scenario ID”, “person who prepared” and “preparation time and date”, are not shown. Not all data item inputs are shown but only those data items that characterize each scenario module are shown as an example. (1) The element hypothesis scenario module A is a composite scenario module comprising the following three element scenario modules.

As scenario data input examples for the element scenario module A(1), “scenario name”=“optimistic estimated market size”, “type definition”=“element”, “scenario evaluation item”=“volume”, “probability value”=0.25, and “actual gain value”=11 billion yen are entered and registered.

As scenario data input examples for the element scenario module A(2), “scenario name”=“expected estimated market size”, “type definition”=“element”, “scenario evaluation item”=“volume”, “probability value”=0.5, and “actual gain value”=10 billion yen are entered and registered.

As scenario data input examples for the element scenario module A(3), “scenario name”=“pessimistic estimated market size”, “type definition”=“element”, “scenario evaluation item”=“volume”, “probability value”=0.25, and “actual gain value”=7 billion yen are entered and registered.

As scenario data input examples for the composite scenario module A, “scenario name”=“estimated market size”, “type definition”=“composite”, “hypothesis description”=“estimated market size”, “scenario evaluation item”=“volume”, “scenario names to be combined”=“optimistic estimated market size”, “expected estimated market size” and “pessimistic estimated market size”, and “combination representation method”=“OR” are entered and registered.

(2) The element hypothesis scenario module B is a composite scenario module comprising the following three element scenario modules.

As scenario data input examples for the element scenario module B(1), “scenario name”=“optimistic estimated share”, “type definition”=“element”, “scenario evaluation item”=“share”, “probability value”=0.2, and “actual gain value”=0.40 are entered and registered.

As scenario data input examples for the element scenario module B(2), “scenario name”=“expected estimated share”, “type definition”=“element”, “scenario evaluation item”=“share”, “probability value”=0.5, and “actual gain value”=0.33 are entered and registered.

As scenario data input examples for the element scenario module B(3), “scenario name”=“pessimistic estimated share”, “type definition”=“element”, “scenario evaluation item”=“share”, “probability value”=0.3, and “actual gain value”=0.25 are entered and registered.

As scenario data input examples for the composite scenario module B, “scenario name”=“estimated share”, “type definition”=“composite”, “hypothesis description”=“estimated share”, “scenario evaluation item”=“share”, “scenario names to be combined”=“optimistic estimated share value”, “expected estimated share value” and “pessimistic estimated share value”, and “combination representation method”=“OR” are entered and registered.

(3) The composite hypothesis scenario module C is created by using the registered composite scenario module A as an intermediate element hypothesis scenario module A and the registered composite scenario module B as an intermediate element hypothesis scenario module B, by entering them as the intermediate element hypothesis scenario modules to be combined and by entering the following inputs.

As scenario data input examples for the composite hypothesis scenario module C, “scenario name”=“estimated sales volume”, “type definition”=“composite”, “hypothesis description”=“future sales volume of the company is”, “scenario evaluation item”=“future estimated sales volume”, “scenario names to be combined”=“estimated market size” and “estimated share”, and “combination representation method”=“AND” are entered and registered.

(4) The data of the composite hypothesis scenario module C created as described above is registered with the scenario module database 310 in a table structure as shown in FIG. 5. This data is read out and is processed by a diagram display program which then outputs a table of estimated sales volume shown in FIG. 22.

When the user makes various decisions, particularly, by taking into considerations text information, such as situation scenarios and decision making selection alternatives, and quantitative data, such as probability values and gain values, the decision support system of this invention can be applied to the decision making and an evaluation and correction of the decision made. Generally, this system can widely be applied to decision making processes in business management and strategy, research and development, marketing, project management, and various risk analyses and management.

It should be further understood by those skilled in the art that although the foregoing description has been made on embodiments of the invention, the invention is not limited thereto and various changes and modifications may be made without departing from the spirit of the invention and the scope of the appended claims.

1. A system for creating a decision making scenario and for supporting a decision making, comprising:
a means to record as definition information data record types of information including at least scenario ID, hypothesis description, scenario occurrence probability, evaluation reference value calculation method, scenario gain value, scenario ID to be combined and combination representation method, and to guide the user in entering data into data items in a template for creating a scenario according to the data record types;
a means to build a decision scenario module by accepting the data that the user has entered according to the guide; and
a means to support the user in selecting a plurality of existing decision making scenario modules as element scenario modules and creating a composite scenario module by combining the element scenario modules.

2. A decision support system according to claim 1, further including:
a database with which the decision scenario modules are registered;
a means to register the scenario module data that the user has entered with the database as element scenario modules according to the data record types of the decision making scenario modules; and
a means to use the plurality of scenario modules registered with the database as element scenario modules and register with the database a composite scenario module composed of the element scenario modules combined by a logical operation the user has chosen.

3. A decision support system according to claim 1, further including:
a means to present, in the process of creating the composite scenario module, to the user a hierarchical structure model of the composite scenario module and the element scenario modules in a table form, a step-by-step tree-branch form or a net form and thereby support the user in understanding a process of creating the composite scenario module.

4. A decision support system according to claim 2, further including:
a means to present, in the process of creating the composite scenario module, to the user a hierarchical structure model of the composite scenario module and the element scenario modules in a table form, a step-by-step tree-branch form or a net form and thereby support the user in understanding a process of creating the composite scenario module.

5. A decision support system according to claim 1, further including:
an evaluation reference value calculation means provided in a database to calculate a plurality of logical rules and methods that form decision making references; and
a means to calculate an evaluated gain from a gain value and an occurrence probability value of a scenario according to the evaluation reference value calculation method selected and entered by the user and present the evaluated gain to the user, wherein the gain value and the occurrence probability value of the scenario being data items of the decision making scenario module used to select the evaluation reference value calculation means.

6. A decision support system according to claim 1, wherein Japanese or English words corresponding to logical symbols or logical relations that describe a logical combination relation between element scenario modules, between an element scenario module and a composite scenario module or between composite scenario modules are used to create a composite scenario module, and a composite scenario module occurrence probability value, an estimated gain value and/or scenario content descriptive text data are processed according to predetermined logical relation rules and computation rules that correspond to the logical relation.

7. A decision support system according to claim 2, wherein Japanese or English words corresponding to logical symbols or logical relations that describe a logical combination relation between element scenario modules, between an element scenario module and a composite scenario module or between composite scenario modules are used to create a composite scenario module, and a composite scenario module occurrence probability value, an estimated gain value and/or scenario content descriptive text data are processed according to predetermined logical relation rules and computation rules that correspond to the logical relation.

8. A decision support system according to claim 3, wherein Japanese or English words corresponding to logical symbols or logical relations that describe a logical combination relation between element scenario modules, between an element scenario module and a composite scenario module or between composite scenario modules are used to create a composite scenario module, and a composite scenario module occurrence probability value, an estimated gain value and/or scenario content descriptive text data are processed according to predetermined logical relation rules and computation rules that correspond to the logical relation.

9. A decision support system according to claim 4, wherein Japanese or English words corresponding to logical symbols or logical relations that describe a logical combination relation between element scenario modules, between an element scenario module and a composite scenario module or between composite scenario modules are used to create a composite scenario module, and a composite scenario module occurrence probability value, an estimated gain value and/or scenario content descriptive text data are processed according to predetermined logical relation rules and computation rules that correspond to the logical relation.

10. A decision support system according to claim 5, wherein Japanese or English words corresponding to logical symbols or logical relations that describe a logical combination relation between element scenario modules, between an element scenario module and a composite scenario module or between composite scenario modules are used to create a composite scenario module, and a composite scenario module occurrence probability value, an estimated gain value and/or scenario content descriptive text data are processed according to predetermined logical relation rules and computation rules that correspond to the logical relation.
